(19) United States
(12) Patent Application Publication
(10) Pub. No.: US 2003/0086110 A1
(43) Pub. Date: May 8, 2003

(54) Use of geographically-referenced imaging device usage information

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/013,235

(22) Filed: Nov. 5, 2001

(51) Int. Cl. B41F 1/00; G06F 15/00

(52) U.S. Cl. 358/1.14

(57) ABSTRACT

Methods and apparatus for analyzing geographically-referenced imaging device usage information can provide a user with detailed information regarding utilization, status and statistics across an imaging device system. This facilitates optimization of the performance of the imaging devices.

### RELATED APPLICATION

This application claims priority to U.S. patent application Ser. No. ______ (Attorney Docket No. 10008071-1), entitled Use Of Geographically-Referenced Imaging Device Usage Information, filed Sep. 28, 2001, which is commonly assigned and incorporated herein by reference.

### TECHNICAL FIELD OF THE INVENTION

The present invention relates generally to imaging device management and in particular the present invention relates to use and evaluation of geographically-referenced imaging device usage information and management of imaging devices.

### BACKGROUND OF THE INVENTION

Imaging devices in organizations are typically implemented as networked service providers in computer networks. Many past and current imaging devices gather information and statistics on their use and operation within the network. Some of the commonly gathered usage information includes job origin, number of pages printed, number of copies of jobs received, number of errors, types of errors, marking material usage (such as ink, toner, thermal material, etc.), marking material level and consumables (such as paper, transparency, etc.) type and usage. In this disclosure imaging devices include, but are not limited to, printers, copiers, facsimile machines, multi-function imaging devices and other such imaging devices.

FIG. 1 details a simplified diagram of an imaging device system. FIG. 1 includes a network backplane 100, imaging devices 102 with imaging device usage information 104, a server 106, workstations 108, and a management facility 110. Each imaging device 102 gathers it own usage information 104. The management facility 110 is typically a software program running on some network device to allow management and querying of the imaging devices 102 across the network. Despite having a facility to allow querying and control of networked imaging devices, organizing and managing imaging device usage information in a manner meaningful to the administrator may be difficult, time consuming or inconvenient.

For the reasons stated above, and for other reasons stated below which will become apparent to those skilled in the art upon reading and understanding the present specification, there is a need in the art for alternative methods of analyzing imaging device usage information and statistics.

### SUMMARY OF THE INVENTION

The above-mentioned problems with analysis of imaging device usage and statistical information gathering and other problems are addressed by the present invention and will be understood by reading and studying the following specification.

For one embodiment, the invention provides a method of improving the performance of one or more imaging devices. The method includes collecting geographically-referenced usage information for the imaging devices, generating one or more performance factors of the imaging devices from the geographically-reference usage information, and generating a recommendation by the imaging device management facility for an improved performance of the imaging devices based on an optimization of the one or more performance factors. For a further embodiment, the method further includes implementing the recommendation.

For another embodiment, the invention provides an imaging device system. The imaging device system includes a network, a management facility in association with the network, and at least one imaging device in communication with the management facility. The management facility is adapted to recommend changes to the imaging device system based on optimization of at least one performance factor generated from geographically-referenced usage information of each of the imaging devices. The optimization of performance factors may take into account user-defined constraints.

For yet another embodiment, the invention provides a computer-usable medium having computer readable instructions stored thereon for execution by a processor to perform a method. The method includes collecting geographically-referenced usage information for one or more imaging devices, generating one or more performance factors from the geographically-referenced usage information, and generating a recommendation for changes to the imaging devices to optimize the one or more performance factors.

The invention further provides apparatus and methods of varying scope.

### BRIEF DESCRIPTION OF THE DRAWINGS

FIG. 1 is a simplified diagram of an imaging device system.

FIG. 2 is a simplified diagram of an imaging device system in accordance with an embodiment of the present invention.

FIG. 3 is a simplified representation of an office space housing an imaging device system and showing supplemental information in accordance with an embodiment of the invention.

FIG. 4 is a simplified representation of an office space housing an imaging device system and showing supplemental information in accordance with a further embodiment of the invention.

FIG. 5 is a network map showing an imaging device system in accordance with an embodiment of the invention.

FIG. 6 is a network tree showing an imaging device system in accordance with an embodiment of the invention.

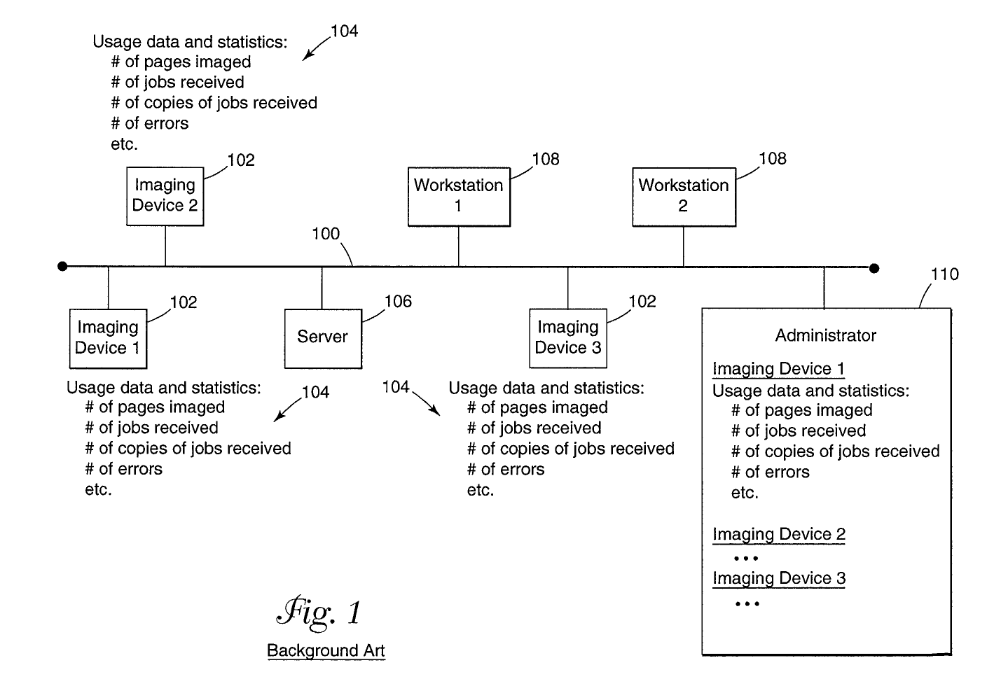

### DETAILED DESCRIPTION OF THE INVENTION

In the following detailed description of the preferred embodiments, reference is made to the accompanying drawings that form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and their equivalents.

The present detailed description describes apparatus and methods for analyzing geographically-referenced imaging device usage information. Embodiments of the present invention analyze imaging device layout and configuration utilizing geographically-referenced imaging device usage information in combination with statistics, geographic constraints, and other supplemental information. Embodiments of the present invention assist with optimization of imaging device placement, tasking and configuration. Analysis of the geographically-referenced usage information is performed by, or under the direction of, an imaging device management facility. The management facility may be a function of a network device, such as a master imaging device, server, workstation or other similar device. The management facility is generally a software program running on some platform or operating system, but such functionality could be expressed in firmware or even hard-coded in a device such as an application-specific integrated circuit (ASIC) chip. In general, however, the management facility includes a set of computer-readable instructions stored on a computer-usable medium for execution by a processor. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

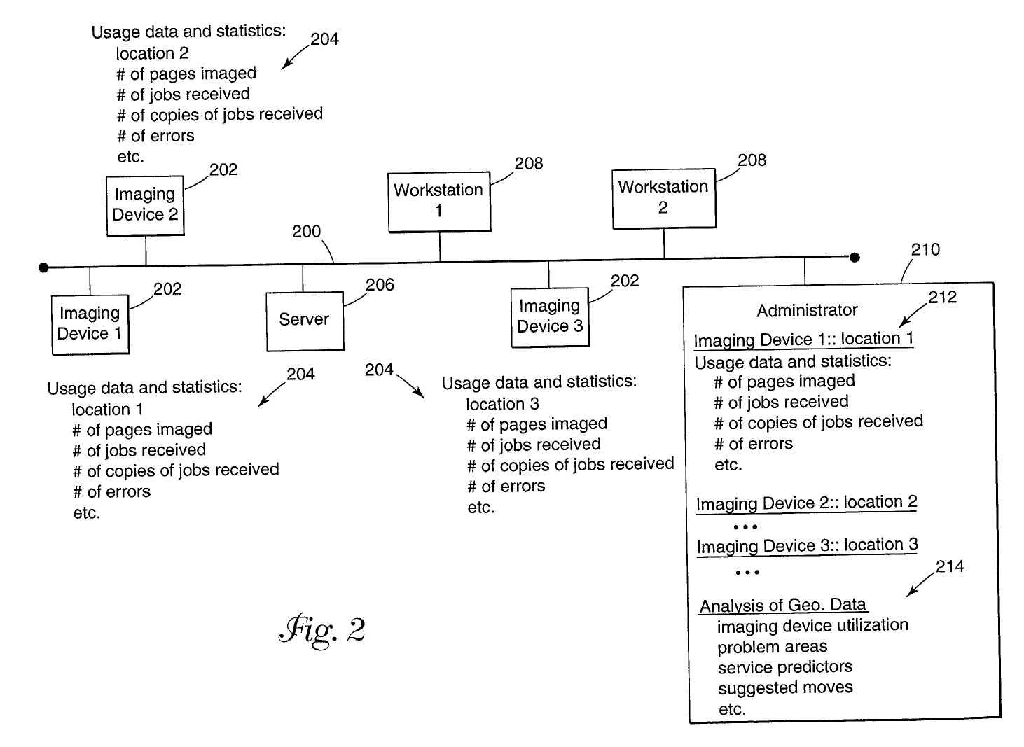

FIG. 2 details a simplified diagram of an imaging device system in accordance with an embodiment of the present invention. FIG. 2 includes a network backplane 200, imaging devices 202 with imaging device usage information 204, a server 206, workstations 208, and an imaging device management facility 210 in accordance with an embodiment of the invention. Each imaging device 202 has a geographic or physical location 212. Each imaging device 202 gathers its own usage information and statistics 204. Alternatively, the usage information and statistics 204 for each imaging device 202 may be gathered by a network device, such as the server 206, the workstations 208, or the imaging device management facility 210. The imaging device usage information includes, but is not limited to, job origin, number of pages imaged, number of copies of jobs received, number of errors, types of errors, marking material usage (such as ink, toner, thermal material, etc.), marking material level and consumables (such as paper, transparency, etc.) type and usage. It is noted that different imaging devices can collect differing usage information depending on imaging device model and configuration.

The imaging device management facility 210 allows management and querying of the imaging devices 202 across the network. Besides providing for management and querying the imaging devices 202, the imaging device management facility 210 generally collects the physical location data and associated usage information from and for the individual imaging devices 202 on an ongoing basis and can allow for collation, display and analysis of the collected data. This geographically-referenced usage information is used in the various embodiments for generation and analysis of system performance factors. An example of an imaging device management facility 210 that allows for management of imaging devices across a network and can be adapted for this purpose includes the WEB JETADMIN™ printer management software program by Hewlett-Packard, Inc., Palo Alto, Calif., USA.

In addition to usage information collected by the imaging devices, supplemental information can also be gathered for analysis by embodiments of the present invention. Supplemental information includes, but is not limited to, geographic constraints on imaging device placement, imaging device configuration, imaging device type, imaging device features and capabilities, and geographic layout and features of the network and/or the facilities housing the network. Additional information, such as local network configuration, network load and facility support features, such as network connections and power connections, can also be utilized to supplement analysis.

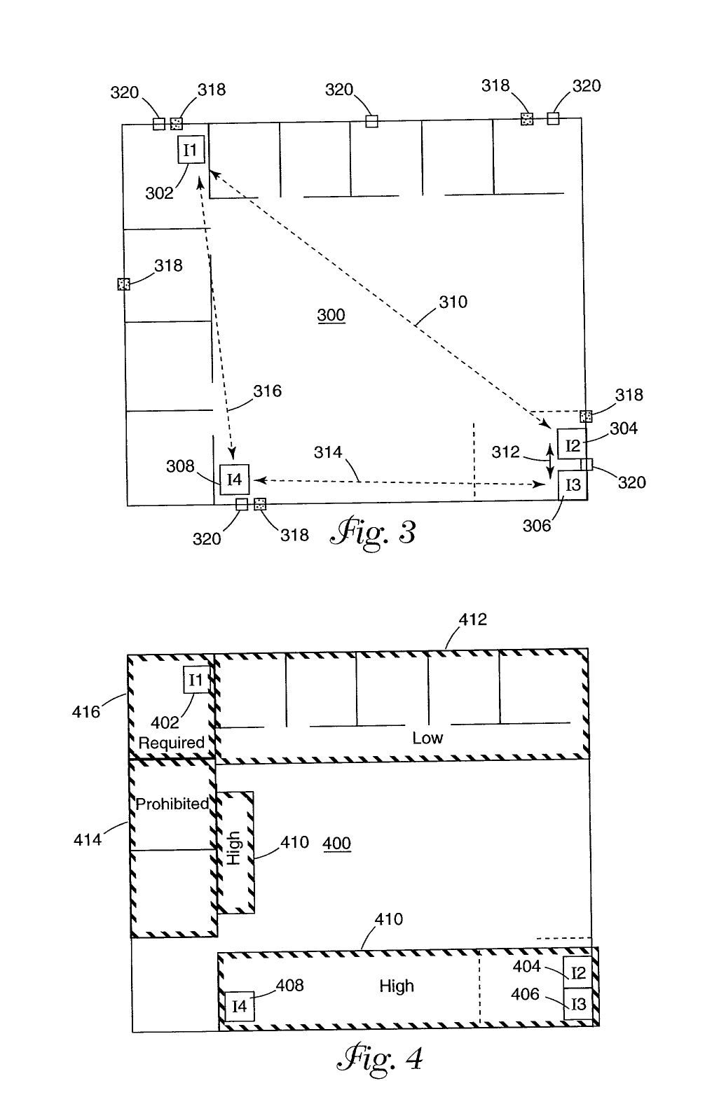

FIG. 3 depicts a simplified representation of an office space 300 housing an imaging device system in accordance with an embodiment of the invention. The office space has four imaging devices, 302, 304, 306 and 308. FIG. 3 demonstrates some of the supplemental information that can be used with embodiments of the invention. Power connections 320 and network connections 318 are shown. Distances 310, 312, 314 and 316 between imaging devices are also shown. It is noted for purposes of this disclosure, that two or more imaging devices, such as imaging devices 304 and 306, can share the same “location” for practical purposes if placed in close proximity, such as in the same room or area.

User input can be solicited for supplemental information. Examples include, but are not limited to, locations of high desirability, locations of low desirability, prohibited locations, required locations and imaging device types. A user of the imaging device system can include end users of the imaging devices as well as other individuals using, monitoring or controlling the imaging device system, such as administrators, technicians and service individuals. An example of such user guidance is shown in FIG. 4. In FIG. 4, a simplified representation of an office space 400 detailing selected user-supplied supplemental information is shown. The office space has four imaging devices, 402, 404, 406 and 408. Areas of high desirability 410 and low desirability 412 are shown. Additionally, FIG. 4 depicts prohibited areas 414, i.e., areas where imaging devices cannot be placed, and required areas 416, i.e., areas that require an imaging device. User input can also define specific methodology and levels to be used in analysis of geographically-referenced usage information.

The geographically-referenced usage information is preferably gathered automatically. Examples of methods of automated data gathering are described in U.S. patent application Ser. No. ______ (Attorney Docket No. 10008070-1), entitled Geographic Imaging Device Management, filed Sep. 28, 2001, which is commonly assigned and incorporated herein by reference. However, such information may also be input to the imaging device management facility using other methods, e.g., by manual entry or by transfer or importation of a formatted data file. The information may be in numerical, text or graphical formats.

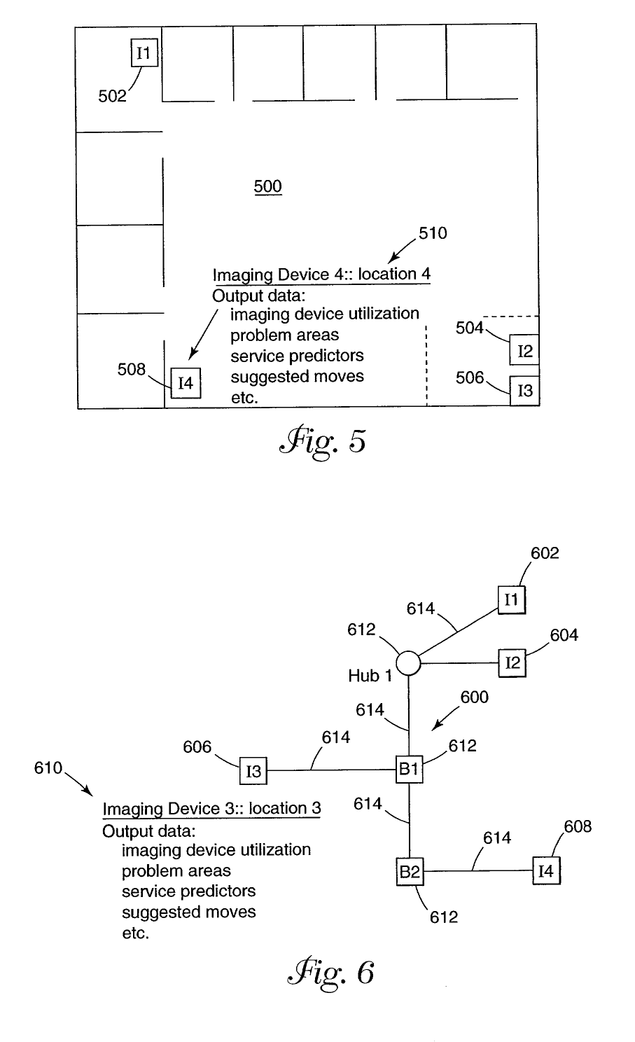

Output data, representing compilations and/or analysis of the geographically-reference usage information and any desired supplemental information, can be presented to a user in a variety of forms, including textual listings, tables, charts and graphical representations. One example includes a bitmap representation of the physical layout of the imaging device system such as shown in FIG. 5. In this example, the user can be presented with a network map 500 showing the imaging devices of the system, e.g., 502, 504, 506 and 508, with relational spacing. For one embodiment, the output data 510 could be displayed in association with each imaging device shown in the network map 500. For another embodiment, the output data 510 could be displayed in association with each location, thus representing a composite of data associated with each imaging device in a location. The output data may take the form of a performance factor, i.e., a factor indicative of a performance of an imaging device of the imaging device system, of a portion of the imaging device system containing two or more imaging devices, or of the whole imaging device system. Some examples include factors that are indicative of cost, utilization, availability or activity level of the imaging device system or its components.

Alternatively, the output data 510 could be displayed for one or more selected imaging devices or locations. As an example, in a dynamic display, a user could highlight or select an imaging device or location using a pointing device and the associated output data 510 could be displayed. Dragging the pointing device to a different imaging device or location would, in turn, display the output data 510 associated with the different imaging device or location.

An alternative graphical display is a network tree 600 where nodes 612, leafs 602, 604, 606 and 608, and connections and branches 614 of the tree represent network devices and their interconnections. Four imaging devices, 602, 604, 606 and 608, are represented in the network tree 600 of FIG. 6. Similar to the network map 500 of FIG. 5, output data 610 could be displayed for each imaging device or location, or only for selected imaging devices or locations. It is noted that alternative manners of presenting output data are possible and should be apparent to those skilled in the art with the benefit of the present disclosure.

The geographically-referenced usage information may be analyzed in a variety of manners. One example includes a mere compilation of usage information for each imaging device in a single location. Another example includes statistical analysis of the usage information for each imaging device or location, such as average number of errors per page of output or average number of pages per job. The usage information for an imaging device or location could also be compared to a threshold level, either a minimum or a maximum. For example, the output data could indicate whether a consumable level is below some desired minimum or whether a utilization of an imaging device is above some desired percentage of its capacity.

In addition to presenting the output data, the management facility can initiate some action in response to the output data. For one embodiment, the management facility can generate messages to a user, e.g., email messages or other alerts. As one example, if a consumable level falls below some desired minimum, the management facility can generate a message to a user that replenishment of the consumable may be desirable. As another example, if a number of errors goes above some desired maximum, the management facility can generate a message to a user suggesting that service may be required. The actions can also be incremental in nature, generating a first action in response to the output data crossing a first threshold value and generating a second action in response to the output data crossing a second threshold value.

In addition to messaging, the actions could also include changing the appearance of the display. For example, if a consumable is below some desired minimum level, the corresponding output data or imaging device on the display could be displayed in yellow while the display could be changed to yellow and flashing if the consumable is depleted. To further the example, if the output data indicates that service is desired or necessary, the display could be red and flashing. The actions could further include placing a service order or purchase order in response to the output data.

In addition, neural net or fuzzy logic analysis can be utilized to give analysis of a comprehensive whole or a subpart of the imaging device system not otherwise possible by conventional means. As an example, using supplemental information, such as placement of power and network connections in conjunction with areas of high/low desirability and required/prohibited areas, the management facility could use the geographically-referenced usage information to suggest placement of imaging devices for more optimal utilization, changes in device configuration or changes in device types. Further examples of such analysis include, but are not limited to, analysis on job data and statistics, such as the pattern of the number of jobs over a given time period in reference to imaging device location, the type of jobs, the number of pages, etc. Similar analysis can also be done singly or in combination with job data and statistics, specialized job types, error data and statistics, consumable data and statistics, or other.

Specific examples of these suggested changes include suggesting changes to imaging device job queuing and job routing; suggesting changing an imaging device to an imaging device with more or less of a specialized capability, such as color, marking material capacity, consumable types, processing capability, or memory queue buffer; suggesting the addition of an imaging device or a change to a higher-capacity imaging device in a high-use location; suggesting the removal of an imaging device or a change to a lower-capacity imaging device for a low-use location; suggesting a repositioning or swap of one or more imaging devices and their placement; and suggesting an addition of an imaging device at a new location or a deletion of an imaging device at an existing location.

Analysis of the output data by the management facility can further include comparisons of output data to find disproportionate usage or occurrence rates. Such job data and statistics include but are not are not limited to, number of jobs, job size, number of pages imaged, number of errors and so forth. This comparison of relative job statistics could be done across all imaging devices or within a geographical sub-area. Comparison can also be done on the number of specialized job types, such as duplexed jobs, color jobs, sorted jobs, specialized paper jobs, etc., across some or all of the managed imaging devices.

Analysis can also be performed on geographically-referenced usage information and supplemental information in light of geographic features of the location(s) (such as distance to other imaging devices or imaging devices of a certain type, and obstruction by corridors, offices, and stairs), physical facility availability (such as network and power outlets and their ratings), or network features of the location (such as network bandwidth and traffic levels available to the network link attached to the imaging device).

For one embodiment, the imaging device management facility is adapted to effect changes to the imaging device system, e.g., changing device configuration or routing, to implement recommended changes. The various embodiments described herein can utilize a management facility residing on a local network site, such as depicted in FIG. 2, or on a remote network site. For example, the management facility may reside on a network remote from the local network containing the imaging devices, such as a remote network belonging to an internal administrator of multiple local networks, a manufacturer of the imaging devices, an equipment leasing company or a service provider. Such remote users could link to one or more local network for periodic or continuous gathering and analysis of geographically-referenced usage information as described herein. This linking of networks could be initiated by a local user, by a remote user, by a passage of time or the occurrence of some event, or by the management facility. Examples of linking include establishing a direct dial-in connection between the networks or transferring data between the networks via an HTTP compatible website, an FTP site, an Email site or other similar network links.

Once analysis of the usage information is performed at the remote site, the analysis results may be transmitted back to a local user or posted for later retrieval by the local user. This could be by any of the above listed manners, such as through a standard Email protocol or Internet browser.

Whether analysis is preformed at a local or remote site, analysis results can include recommendations for improved performance of the imaging device system. For one embodiment, the analysis results include recommendations for a more optimized placement of existing imaging devices. For another embodiment, the analysis results include recommendations for replacement, deletion or addition of one or more imaging devices. Improved performance may be based upon optimizing one or more performance factors including load leveling among imaging devices of a particular type; average distance between a user and a job; average cost per job; imaging device utilization; and other performance factors. The improved performance may further be based on optimizing a weighted composite of two or more of the performance factors determined from the geographically-referenced usage information. Optimizing of the one or more performance factors may further be governed by one or more user-defined constraints, such as areas of high or low desirability, placement of network or power connections, budgets for upgraded or additional imaging devices, etc.

### CONCLUSION

Methods and apparatus for analyzing geographically-referenced imaging device usage information have been described. Such analysis provides a user with detailed information regarding utilization, status and statistics across a network of imaging devices. This facilitates optimization of performance of an imaging device system. Such analysis can also be used to help identify printing issues or to verify improvements made to the system in response to a previous analysis.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of improving the performance of one or more imaging devices, the method comprising:
collecting geographically-referenced usage information for the imaging devices;
generating one or more performance factors of the imaging devices from the geographically-reference usage information; and
generating a recommendation by the imaging device management facility for an improved performance of the imaging devices based on an optimization of the one or more performance factors.

2. The method of claim 1, further comprising implementing the recommendation.

3. The method of claim 2, wherein implementing the recommendation comprises changing configuration or routing for one or more of the imaging devices.

4. The method of claim 1, wherein generating a recommendation comprises generating a recommendation from a network site remote from one or more of the imaging devices.

5. The method of claim 1, wherein collecting geographically-referenced usage information comprises an automated data gathering method.

6. The method of claim 1, wherein the recommendation is selected from the group consisting of a placement of the imaging devices, a replacement of one or more of the imaging devices, a deletion of one or more of the imaging devices, an addition of one or more imaging devices, a suggested service of one or more of the imaging devices, and a suggested replenishment of a consumable of one or more of the imaging devices.

7. The method of claim 6, wherein the recommendation accounts for supplemental information.

8. The method of claim 7, wherein the supplemental information comprises location of areas of high or low desirability for imaging device placement, location of areas having a requirement for or a prohibition of imaging devices, placement of network or power connections, and desired minimums or maximums for a performance factor.

9. The method of claim 1, further comprising:
implementing the recommendation;
wherein the recommendation is selected from the group consisting of a placement of the imaging devices, a replacement of one or more of the imaging devices, a deletion of one or more of the imaging devices, an addition of one or more imaging devices, a suggested service of one or more of the imaging devices, and a suggested replenishment of a consumable of one or more of the imaging devices; and
wherein the recommendation accounts for user-defined constraints.

10. The method of claim 9, wherein implementing the recommendation comprises implementing the recommendation from a network site remote from one or more of the imaging devices.

11. An imaging device system comprising:
a network;
a management facility in association with the network; and
at least one imaging device in communication with the management facility;
wherein the management facility is adapted to recommend changes to the imaging device system based on optimization of at least one performance factor generated from geographically-referenced usage information of each of the imaging devices.

12. The imaging device system of claim 11, wherein the imaging device management facility is located on a network site remote from one or more of the imaging devices.

13. The imaging device system of claim 11, wherein the recommended changes include at least one change selected from the group consisting of a placement of the imaging devices within the imaging device system, a replacement of one or more of the imaging devices, a deletion of one or more of the imaging devices, an addition of one or more imaging devices to the imaging device system, a suggested service of one or more of the imaging devices, and a suggested replenishment of a consumable of one or more of the imaging devices.

14. The imaging device system of claim 13, wherein the recommended changes account for supplemental information regarding the imaging device system.

15. The imaging device system of claim 14, wherein the supplemental information comprises at least one datum selected from the group consisting of location of an area of high or low desirability for imaging device placement, location of an area having a requirement for or a prohibition of imaging devices, placement of a network or a power connection, and a desired minimum or maximum threshold for a performance factor.

16. A computer-usable medium having computer readable instructions stored thereon for execution by a processor to perform a method comprising:
collecting geographically-referenced usage information for one or more imaging devices;
generating one or more performance factors from the geographically-referenced usage information; and
generating a recommendation for changes to the imaging devices to optimize the one or more performance factors.

17. The computer-usable medium of claim 16, wherein the method further comprises:
implementing the recommendation.

18. The computer-usable medium of claim 17, wherein implementing the recommendation comprises making changes to a configuration or routing of one or more of the imaging devices.

19. The computer-usable medium of claim 16, wherein the recommendation is selected from the group consisting of a placement of the imaging devices, a replacement of one or more of the imaging devices, a deletion of one or more of the imaging devices, an addition of one or more imaging devices, a suggested service of one or more of the imaging devices, and a suggested replenishment of a consumable of one or more of the imaging devices.

20. The computer-usable medium of claim 16, further comprising:
implementing the recommendation;
wherein the recommendation is selected from the group consisting of a placement of the imaging devices, a replacement of one or more of the imaging devices, a deletion of one or more of the imaging devices, an addition of one or more imaging devices, a suggested service of one or more of the imaging devices, and a suggested replenishment of a consumable of one or more of the imaging devices; and
wherein the recommendation accounts for user-defined constraints.
